(19) United States
(12) Patent Application Publication
(10) Pub. No.: US 2011/0199001 A1
(43) Pub. Date: Aug. 18, 2011

(54) LED ILLUMINATION DEVICE

(76) Inventor: Hung-Wen LEE, Taipei City (TW)

(21) Appl. No.: 12/705,583

(22) Filed: Feb. 13, 2010

(51) Int. Cl. H01J 13/32; H05B 39/00

(52) U.S. Cl. 315/113; 315/312

(57) ABSTRACT

The present invention relates to a LED illumination device, capable of being combined with a fluorescent lamp, comprises a connector; a substrate capable of being clamped on a lamp tube; a plurality of light emitting diodes; a driving member; and a rectifying and stabilizing member. With the mentioned structure of the LED illumination device, the LED illumination device is able to be directly fastened on the lamp tube of existed fluorescent lamp, for providing LED illumination and lowering replacement cost and increasing replacement convenience.

### BACKGROUND OF THE INVENTION

1. Field of the Invention

The present invention relates to a LED illumination device, especially to a LED illumination device capable of being directly fastened on a lamp tube of existed fluorescent lamp for providing LED illumination, lowering replacement cost and increasing replacement convenience.

2. Description of Related Art

A conventional fluorescent lamp is mostly installed with a lamp seat, a starter and a lamp tube, wherein the lamp tube can be in a round or straight shape. The fluorescent lamp has disadvantages of power consuming and light flashing.

Compared to the fluorescent lamp, a LED illumination device has advantages of saving power and eliminating light flashing, so the fluorescent lamp is gradually replaced by the LED illumination device.

Speaking of LED illumination devices that have been launched in the market or granted patents related to LED illumination devices, the LED illumination device has its certain lamp seat, so when a replacement is performed, the originally existed fluorescent lamp has to be removed then the new LED illumination device is able to be installed, therefore the replacement cost of this operation is relatively high and consumes more time during the installation.

For improving the mentioned disadvantages of conventional LED illumination device, the present invention provides a novel LED illumination device.

### SUMMARY OF THE INVENTION

One primary object of the present invention is to provide a LED illumination device capable of being directly fastened on the lamp tube of existed fluorescent lamp for providing LED illumination.

Another object of the present invention is to provide a LED illumination device capable of being directly fastened on the lamp tube of existed fluorescent lamp for lowering replacement cost.

One another object of the present invention is to provide a LED illumination device capable of being directly fastened on the lamp tube of existed fluorescent lamp for reducing installation duration.

For achieving the mentioned objects, a LED illumination device is provided by the present invention, capable of being combined with a fluorescent lamp, wherein the fluorescent lamp includes a lamp seat, a starter, a lamp tube and a power cable, one end of the power cable is coupled to an AC power source, the LED illumination device comprises a connector, one end thereof is coupled to the other end of the power cable for obtaining required AC power; a substrate having at least two clamping members for being clamped on the lamp tube; a plurality of light emitting diodes disposed on the substrate; a driving member coupled to the light emitting diodes for driving the light emitting diodes; a rectifying and stabilizing member, one end thereof is coupled to the connector for obtaining required AC power, the other end thereof is coupled to the light emitting diodes and the driving member for supplying required DC power.

### BRIEF DESCRIPTION OF THE DRAWINGS

FIG. 1 is a schematic exploded view of the LED illumination device of one preferred embodiment of the present invention;

FIG. 2 is a schematic view illustrating the back side of the substrate of the LED illumination device of one preferred embodiment of the present invention being respectively installed with at least two clamping members and a heat dissipating device;

FIG. 3 is a schematic view of the assembly of the LED illumination device of one preferred embodiment of the present invention;

FIG. 4 is a schematic view illustrating the LED illumination device of one preferred embodiment of the present invention after being assembled with a fluorescent lamp.

### DETAILED DESCRIPTION OF THE PREFERRED EMBODIMENT

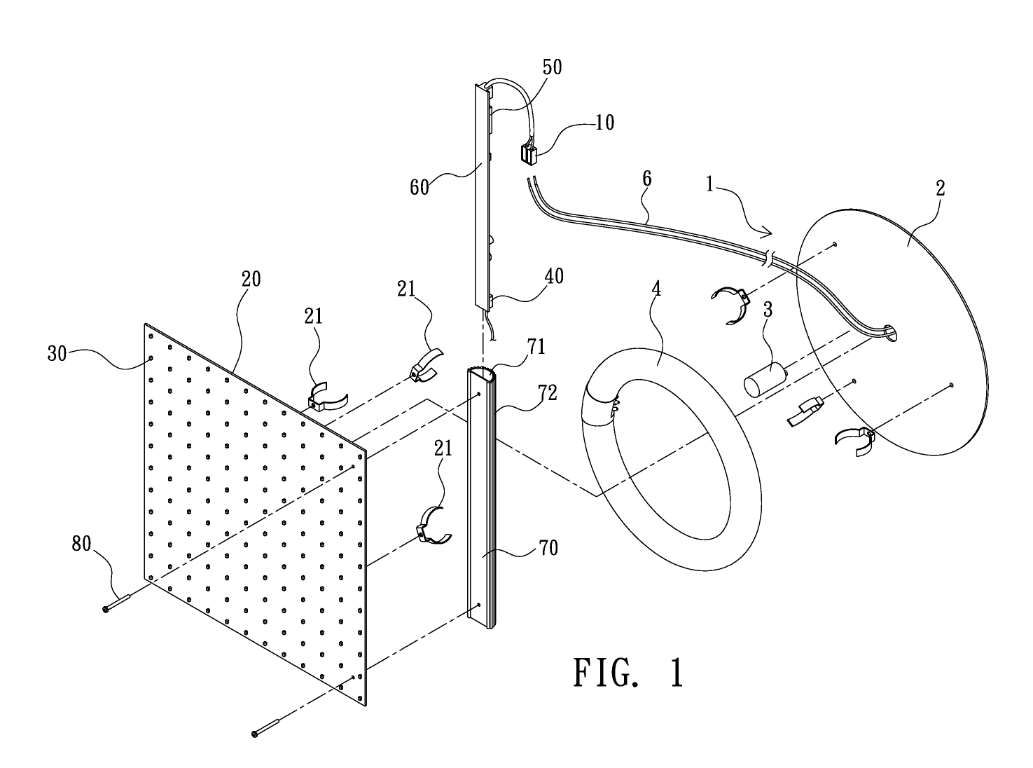

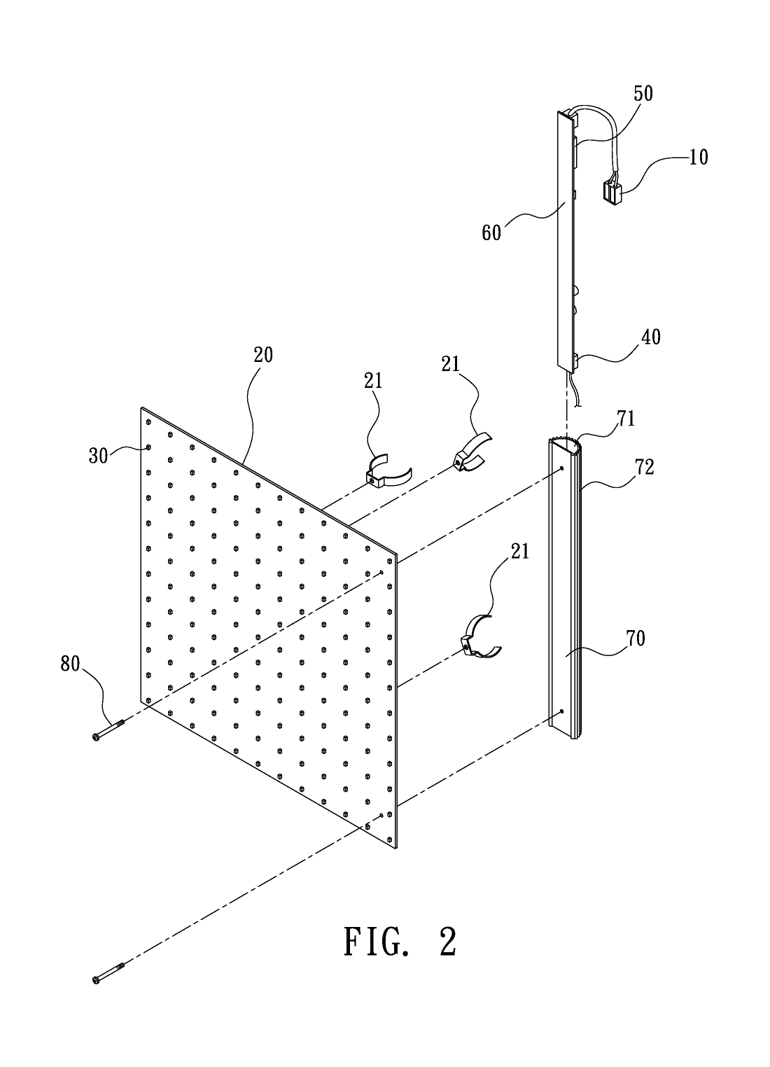

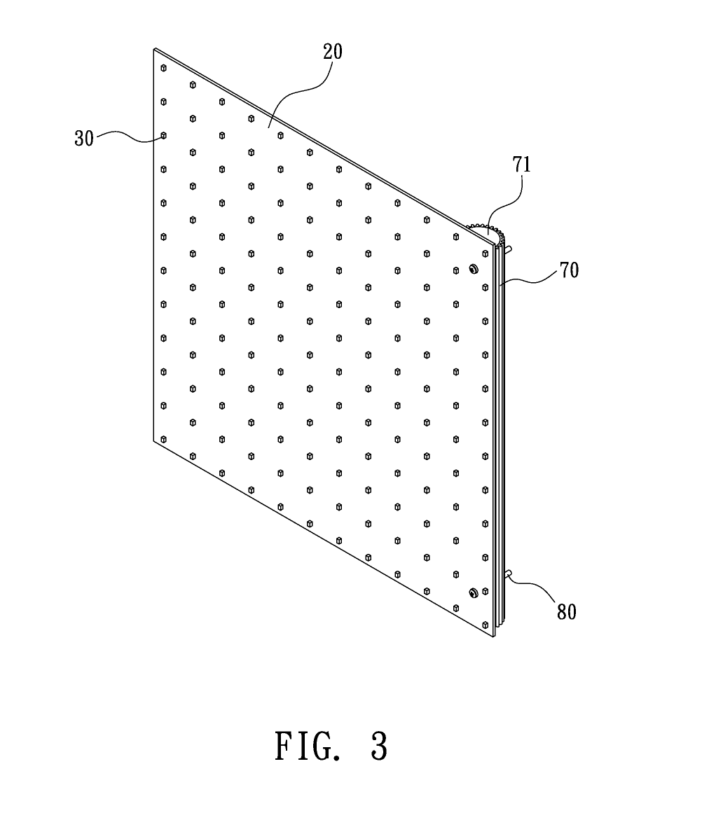

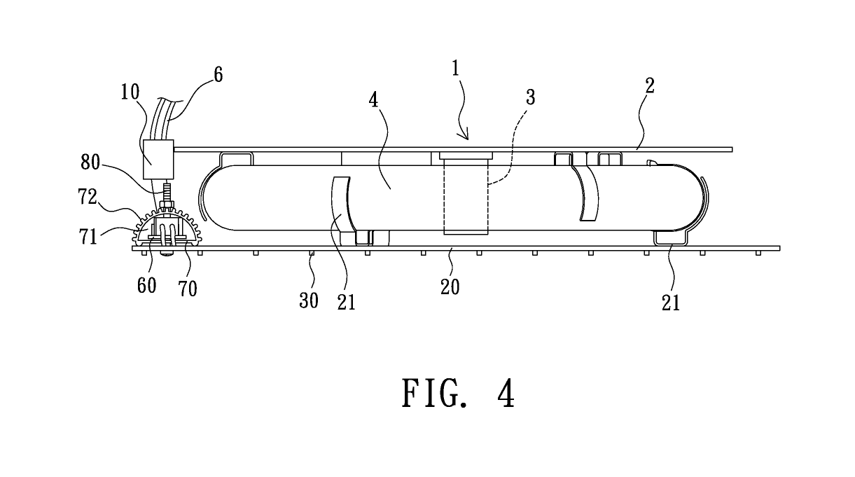

Referring from FIG. 1 to FIG. 4, wherein FIG. 1 is a schematic exploded view of the LED illumination device of one preferred embodiment of the present invention; FIG. 2 is a schematic view illustrating the back side of the substrate of the LED illumination device of one preferred embodiment of the present invention being respectively installed with at least two clamping members and a heat dissipating device; FIG. 3 is a schematic view of the assembly of the LED illumination device of one preferred embodiment of the present invention; FIG. 4 is a schematic view illustrating the LED illumination device of one preferred embodiment of the present invention after being assembled with a fluorescent lamp.

As shown in figures, the LED illumination device provided by the present invention is capable of being combined with a fluorescent lamp 1 for providing illumination, wherein the fluorescent lamp 1 includes a lamp seat 2, a starter 3, a lamp tube 4 and a power cable 6, one end of the power cable 6 is coupled to an AC power source, and the mentioned units are conventional units so no further illustration is provided. The LED illumination device provided by the present invention comprises a connector 10; a substrate 20; a plurality of light emitting diodes 30; a driving member 40 and a rectifying and stabilizing member 50.

One end of the connector 10 is coupled to the other end of the power able 6 for obtaining required AC power, e.g. but not limited to AC110V or AC220V. In this embodiment of the present invention, when the connector 10 is connected to the power cable 6, the starter 3 does not need to be removed, and the lamp tube 4 is not able to be actuated because the AC power is terminated.

The substrate 20 has at least two clamping members 21 for being clamped on the lamp tube 4; in this embodiment of the present invention, three clamping members 21 are adopted for illustration and not served as a limitation, and the three clamping members 21 are able to be spaced with an equal distance on the back side of the substrate 20, and the clamping members 21 are fastened on the substrate 20 through screws 22. The lamp tube 4 is, e.g. but not limited to, a round-shaped fluorescent lamp tube and the whole appearance of the fluorescent lamp tube can be in a round or elongated shape; in this embodiment, a round lamp tube is adopted for illustration and not served as a limitation. The substrate 20 is, e.g. but not limited to, an aluminum substrate.

The light emitting diodes 30 are, e.g. but not limited to, high brightness white light LEDs, and are disposed on the substrate 20, e.g. but not limited to the front side of the substrate 20, and are arranged with, e.g. but not limited to, a matrix manner.

The driving member 40 is coupled to the light emitting diodes 30 for driving the light emitting diodes 30.

One end of the rectifying and stabilizing member 50 is coupled to the connector 10 for obtaining required AC power, the other end thereof is coupled to the light emitting diodes 30 and the driving member 40 for supplying required DC power.

The LED illumination device of the present invention is further provided with a printed circuit board 60 for receiving the driving member 40 and the rectifying and stabilizing member 50.

As shown in FIG. 2, the LED illumination device provided by the present invention is further installed with a heat dissipating device 70 fastened on the side of the substrate 20 where the clamping members 21 are installed, and having a chamber 71 for receiving the printed circuit board 60, and the periphery of the heat dissipating device 70 is further installed with a plurality of heat dissipating fins 72 for facilitating the heat dissipation of the substrate 20; wherein the heat dissipating device 70 is an aluminum board.

As shown in FIG. 3, when being assembled, the light emitting diodes 30 can be firstly welded on the substrate 20; then the driving member 40 and the rectifying and stabilizing member 50 are welded on the printed circuit board 60 received in the heat dissipating device 70, then the printed circuit board 60 is fastened in the chamber 71; lastly a lock member 80, e.g. but not limited to a screw set, is served to fasten the heat dissipating device 70 and the printed circuit board 60 on the substrate 20; the assembly of the LED illumination device provided by the present invention is therefore finished.

As shown in FIG. 4, when being installed, the clamping members 21 are clamped on the lamp tube 4; then the connector 10 is connected to the power cable 6 for obtaining the required AC power, the AC power is rectified and stabilized by the rectifying and stabilizing member 50 so as to obtain the required DC power for supplying to the driving member 40 and the light emitting diodes 30; lastly the light emitting diodes 30 are driven by the driving member 40 for providing LED illumination. So the lamp seat 2 of the fluorescent lamp 1 is kept for lowering the replacement cost and increasing the installation convenience.

According to what is mentioned above, the LED illumination device provided by the present invention can improve disadvantages of conventional LED illumination device.

As mentioned above, the LED illumination device provided by the present invention, compared to conventional LED illumination devices, has flowing advantages: 1. capable of being directly fastened on the lamp tube of existed fluorescent lamp for providing required LED illumination; 2. capable of being directly fastened on the lamp tube of existed fluorescent lamp for lowering the replacement cost; and 3. capable of being directly fastened on the lamp tube of existed fluorescent lamp for saving replacement duration and labors. Thus, the LED illumination device provided by the present invention is novel compared to conventional LED illumination devices.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A LED illumination device, capable of being combined with a fluorescent lamp having a lamp seat, a starter, a lamp tube and a power cable of which one end is coupled to an AC power source, comprising:
a connector, one end thereof being coupled to the other end of said power cable for obtaining required AC power;
a substrate having at least two clamping members for being clamped on said lamp tube;
a plurality of light emitting diodes disposed on said substrate;
a driving member coupled to said light emitting diodes for driving said light emitting diodes;
a rectifying and stabilizing member, one end thereof being coupled to said connector for obtaining required AC power, the other end thereof being coupled to said light emitting diodes and said driving member for supplying required DC power.

2. The LED illumination device as claimed in claim 1, wherein said substrate is an aluminum substrate.

3. The LED illumination device as claimed in claim 1, wherein said two clamping members are disposed at the back side of said substrate.

4. The LED illumination device as claimed in claim 3, wherein said light emitting diodes are disposed at the front side of said substrate arranged with a matrix manner.

5. The LED illumination device as claimed in claim 1, wherein said light emitting diodes are high brightness white-light light emitting diodes.

6. The LED illumination device as claimed in claim 5, wherein being further installed with a printed circuit board for receiving said driving member and said rectifying and stabilizing member.

7. The LED illumination device as claimed in claim 6, wherein being further installed with a heat dissipating device fastened on the side of said substrate where said two clamping members are installed, and having a chamber for receiving said printed circuit board.

8. The LED illumination device as claimed in claim 7, wherein said heat dissipating device is an aluminum board and the periphery thereof is further installed with a plurality of heat dissipating fins.

9. The LED illumination device as claimed in claim 1, wherein said lamp tube is a round or elongated lamp tube.
